(19) United States
(12) Patent Application Publication
(10) Pub. No.: US 2017/0333778 A1
(43) Pub. Date: Nov. 23, 2017

(54) GRAPHICAL LINE-UP TOOL FOR YOUTH BASEBALL

(71) Applicant: David J. Lavin, Chandler, AZ (US)

(72) Inventor: David J. Lavin, Chandler, AZ (US)

(21) Appl. No.: 15/162,433

(22) Filed: May 23, 2016

(51) Int. Cl. A63B 71/06; G06F 3/0484; G06F 3/0482

(52) U.S. Cl. CPC A63B 71/0616; G06F 3/0482; G06F 3/04842

(57) ABSTRACT

A graphical software tool is provided that allows a user to create a youth baseball team roster, schedule baseball games for a season, assign player positions for a game, formulate a batting order, rank individual player strength level by position, estimate a strength level of an entire line-up, and provide various game and player statistics. League-specific policies such as pitch count limits, pitcher rest requirements, and pitcher/catcher limitations can be included in a rules base that must be adhered to during line-up creation. If an error is found, a warning or error message can be displayed. In some cases, such errors will prevent finalization of a task such as creation of a line-up. Additional aspects of the present invention include use of color coding and other graphical elements, recording pitch counts, printing line-up cards, and calculating individual player batting and pitching statistics and team batting and pitching statistics.

### BACKGROUND OF THE INVENTION

### 1. Field of the Invention

The present invention relates to sports team coaching, and more particularly, to a computer system and computer-implemented method for scheduling and managing a youth baseball team.

### 2. Description of the Related Art

Youth baseball for players up to about age thirteen is very different from high school and club baseball which tends to be more competitive. There are numerous league-specific policies coaches must follow involving such matters as having minimal play time for each player, assigning players to varying field positions, and not having “favorites”. Failure to follow these rules may result in negative comments from parents and, in some cases, sanctions from the league. There is a delicate balance of trying to win games, teaching the game, and making sure the players are having fun.

Moreover, coaches must employ good organizational skill in scheduling games and creating team line-ups that adhere to the rules of baseball and the league-specific rules, but without adequate tools, mishaps occur. For example, coaches may inadvertently assign two players to a single position, accidentally leave a position unassigned, or assign one player to the bench for multiple innings while another is on the field for the entire game. This can be not only embarrassing for the coach and players, but also may require the coach to spend valuable time making last minute adjustments to resolve such mishaps.

Traditionally, planning and preparing a team line-up with batting order and position assignments before the game is done on a notepad or the like and sometimes may involve use of a rudimentary spreadsheet program. However, these conventional approaches are error prone and not optimal for use in preparing a baseball line-up or game plan for youth baseball.

### SUMMARY OF THE INVENTION

A graphical software tool is provided that allows a user to create a youth baseball team roster, schedule baseball games for a season, assign player positions for a game, formulate a batting order, rank individual player strength level by position, estimate a strength level of an entire line-up, and provide various game and player statistics. League-specific policies such as pitch count limits, pitcher rest requirements, and pitcher/catcher limitations can be included in a rules base that must be adhered to during line-up creation. If an error is found, a warning or error message can be displayed. In some cases, such errors will prevent finalization of a task such as creation of a line-up. Additional aspects of the present invention include use of color coding and other graphical elements, recording pitch counts, printing line-up cards, and calculating individual player batting and pitching statistics and team batting and pitching statistics.

### BRIEF DESCRIPTION OF THE DRAWINGS

FIG. 1 illustrates an exemplary implementation of a system that provides a graphical line-up tool via the Internet, according to an embodiment of the present invention.

FIG. 2 illustrates exemplary functionality provided by the graphical line-up tool, in accordance with the present invention.

FIG. 3 illustrates an exemplary roster screen template for an application in accordance with the present invention.

FIG. 4 illustrates the roster screen page template of FIG. 3 filled out, in accordance with the present invention.

FIG. 5 illustrates an exemplary screen game schedule page, in accordance with the present invention.

FIG. 6 and FIG. 7 illustrate exemplary batting and fielding line-up screen pages, in accordance with the present invention.

FIG. 8 illustrates an exemplary batting and fielding order printout, in accordance with the present invention.

FIG. 9 illustrates an exemplary line-up card, in accordance with the present invention.

FIG. 10 illustrates an exemplary batting and pitching statistics screen page, in accordance with the present invention.

FIG. 11 illustrates an exemplary individual and team batting and pitching printout.

FIGS. 12-19 illustrate exemplary database data structures useful for implementing the graphical line-up tool, in accordance with the present invention.

### DETAILED DESCRIPTION OF THE INVENTION

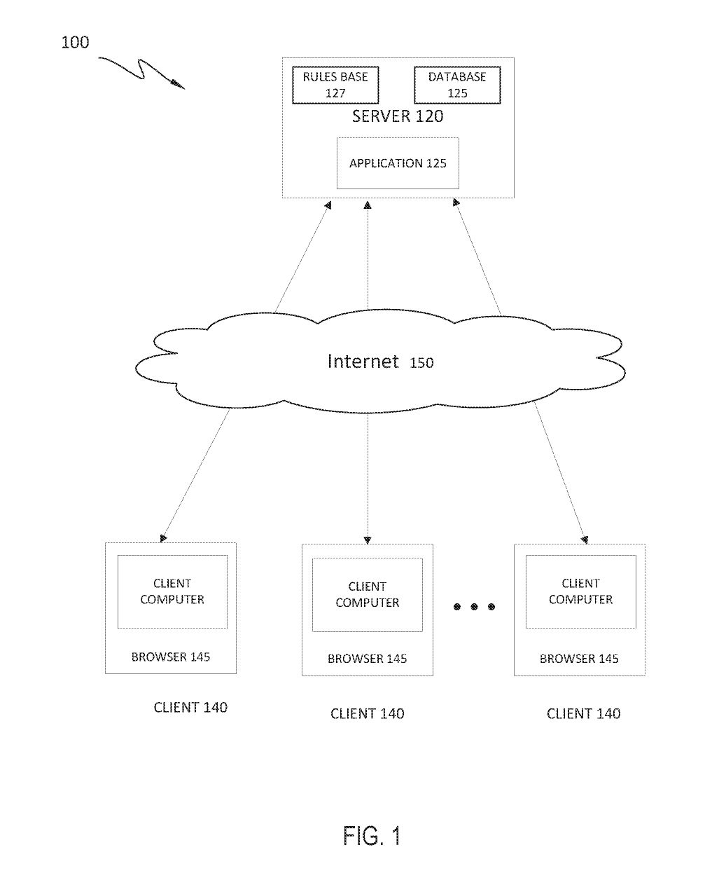

Referring to FIG. 1, an exemplary diagram of a web-based system 100 is shown. As depicted, the system 100 includes a distributed application which is partitioned between a service provider (server 120) and a plurality of service requesters (clients 140). Under this arrangement, a request-response protocol, such as hypertext protocol (HTTP), can be employed such that a client 140 can initiate requests for services from the server 120, and the server 120 can respond to each respective request by, for example, executing an application 125 on the server 120, and (where appropriate) sending results to the client 140. The server 120 also includes a database 125 and a rules base 127 operatively linked to the server, allowing the application 125 to query and store data therein. It is to be understood that in some embodiments, however, substantial portions of the application logic may be performed on the client 140 using, for example, the AJAX (Asynchronous JavaScript and XML) paradigm to create an asynchronous web application. Furthermore, it is to be understood that in some embodiments the application 125 can be distributed among a plurality of different servers 120 (not shown). Furthermore, in still other embodiments, the application 125 can be implemented on a single standalone computer system (e.g., a personal computer) with its own operating system software.

Preferably, the illustrated entities (the server 120 and the clients 140) communicate via the Internet 150 which provides a path for data communication, and allows exchange of information signals. Although the Internet 150 is depicted as being used for communication among the illustrated entities, it is to be understood that other network elements could, alternatively, or in addition, be used.

In the following description of the present invention, exemplary methods for performing various aspects of the present invention are disclosed. It is to be understood that the steps illustrated herein can be performed by executing computer program code written in a variety of suitable programming languages, such as C, C++, C#, Visual Basic, and Java. It is also to be understood that the software of the invention will preferably further include various Web-based applications 125 that can be written in HTML, PHP, Javascript, jQuery, etc., accessible by the clients 140 using a suitable browser 145 (e.g., Internet Explorer, Microsoft Edge, Mozilla Firefox, Google Chrome, Safari, Opera).

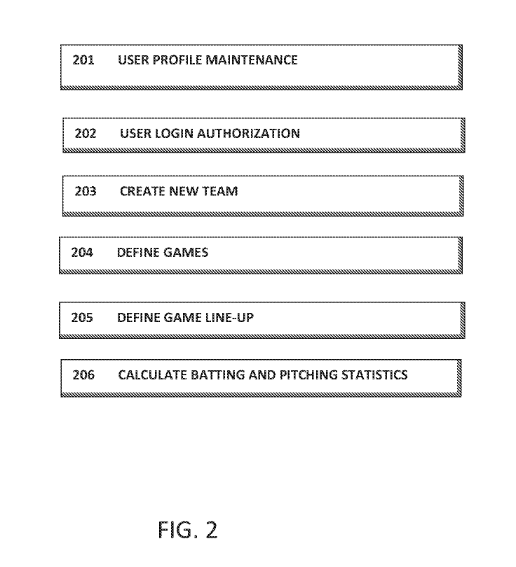

Referring to FIG. 2, exemplary functionality provided by the application 125 is illustrated. As shown, the application 125 includes a user profile maintenance module 201, a user login authorization module 202, a create/update team information module 203, a schedule games module 204, a define game line-up module 205, and a calculate batting and pitching statistics module 206. It is to be understood that the functionality for each of the illustrated modules could be implemented by more than one software module. It is further to be understood that additional (or less) functionality could be included.

User Profile Maintenance 201

In accordance with an embodiment, each user will be required to maintain a user profile to access the system 100. In order to use the application 125, the user will preferably “register” and provide a user profile. The user profile can include the user's name and email address, and authentication information such as a user id and a password. Depending on the payment model, the user may also have to provide payment (e.g., credit card, debit card) information for recurring payments.

User Login Authorization 202

In accordance with an embodiment, the user will need to log into the system 100 using valid authentication credentials. The authorization credentials will be the userid/password combination previously created. Depending on the level of security required, credential information could be transferred using encryption (e.g., a secure sockets layer). Once successfully logged in, control will be passed to a main or “Home Page,” for example.

Create/Update Team Information 203

In accordance with an embodiment, the “Home Page” for the user will show the team(s) associated with the user. If no team is associated with the user or the user wants to create another team, the user will be provided with a screen to create the new team. Once the desired team(s) have been defined and named, a logo can optionally be assigned to the team. For example, a team such as “Jr. Diamondbacks” might have an illustration of a diamondback rattlesnake. The logo can be uploaded as an image file (e.g., a JPEG, GIF file) and thereafter displayed on the Home Page, for example. Thereafter, the user would merely have to click on the appropriate team logo to access the appropriate team information. Additionally, the user can define an email distribution list (e.g., a list of email addresses to which potential line-ups are distributed to coaches for their review). Additional data may be entered on the team profile page, such as number of innings to be played, number of players in the line-up, and/or other team data. Policies such as playing time requirements can be controlled such as by issuing an error or warning, or turning this feature off.

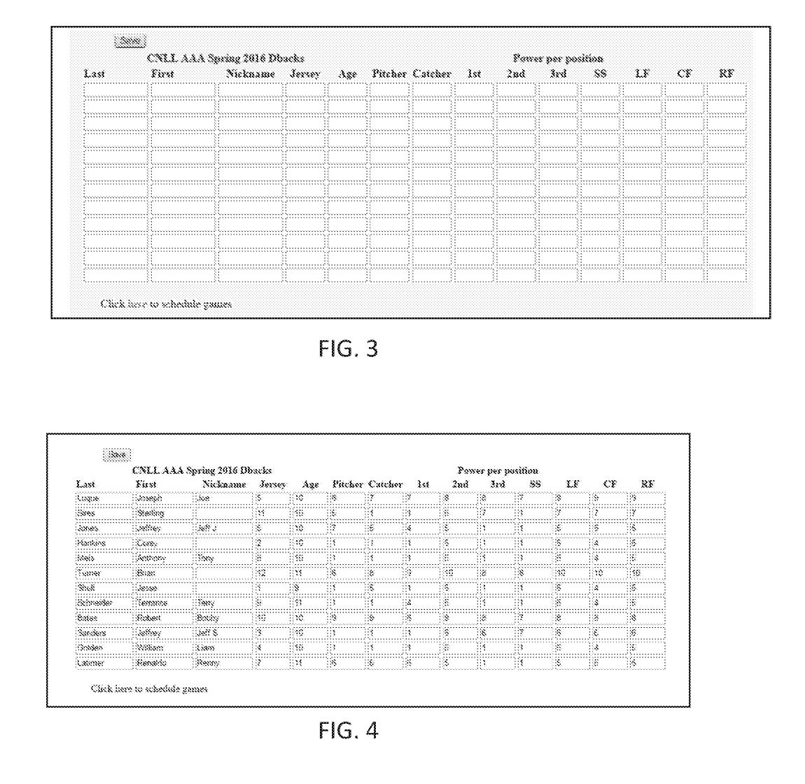

In accordance with an embodiment, the first time a user clicks on a team logo, a team roster page will be displayed. Here, the user can input the full team roster. An example blank team roster page template is shown at FIG. 3, and the same form filled out is shown at FIG. 4. As illustrated, entries are entered in a tabular format, and include each team member's name, nickname, jersey number, and age. One additional entry “Power Per Position,” allows the user to assign an integer from 1 to 10 quantifying a player's estimated ability level (proficiency) for each field position (pitcher, catcher, first base, second base, third base, shortstop, left field, center field, and right field) for depth chart ranking. In this case, a higher value number indicates a greater proficiency. However, it is to be understood that a different ranking scheme could be used, such as where a lower value number indicates greater proficiency, a letter ranking system, e.g., “A” for highest level, “B” for the second highest level, etc. In general, any suitable ranking scheme may be used to assign proficiency levels.

Schedule Games Module 204

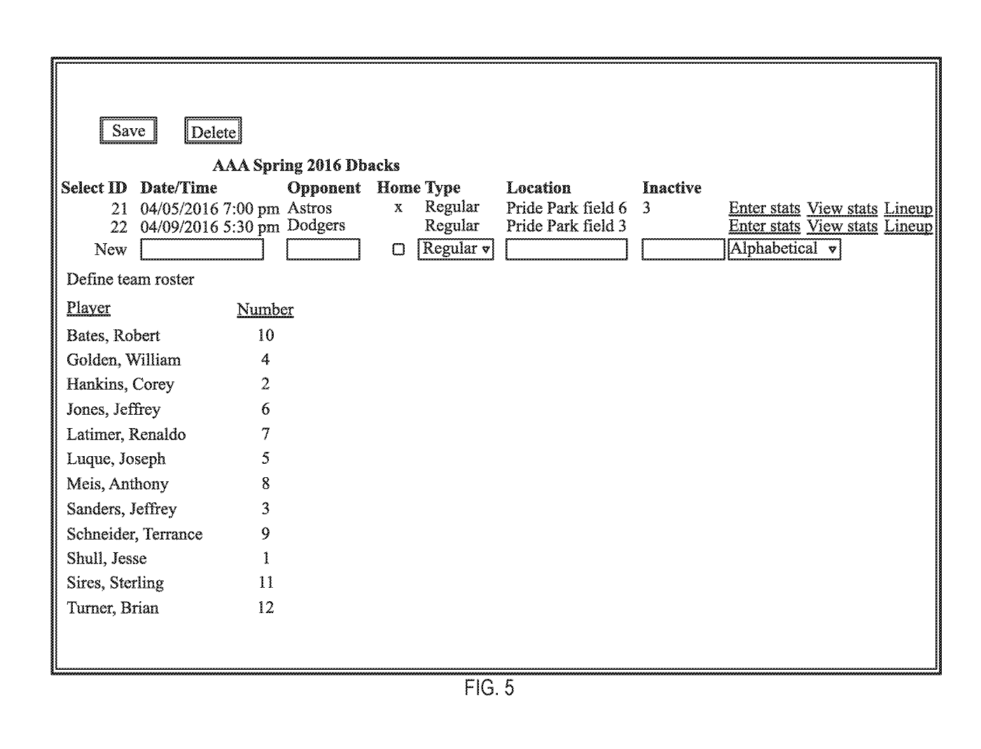

In accordance with an embodiment, once the team roster is in place, the user can click on the team logo of the “Home Page” to navigate to a game schedule page to define the games. Alternatively, a link on the team roster page (as seen at FIGS. 3-4) will also navigate to the game schedule page. The game schedule page, shown at FIG. 5, displays past games and upcoming games, and enables the user to define future games. As shown, a new game can be defined by entries for the date/time, opponent name, home game indicator, type of game, location, and the number of inactive players. Such information may be entered using various graphical widgets such as text boxes, pull-down menus, radio buttons, etc. If a player will be absent, the user may enter this information when making the line-up, and the list of inactive players can be displayed on the game schedule page.

Define Game Line-Up Module 205

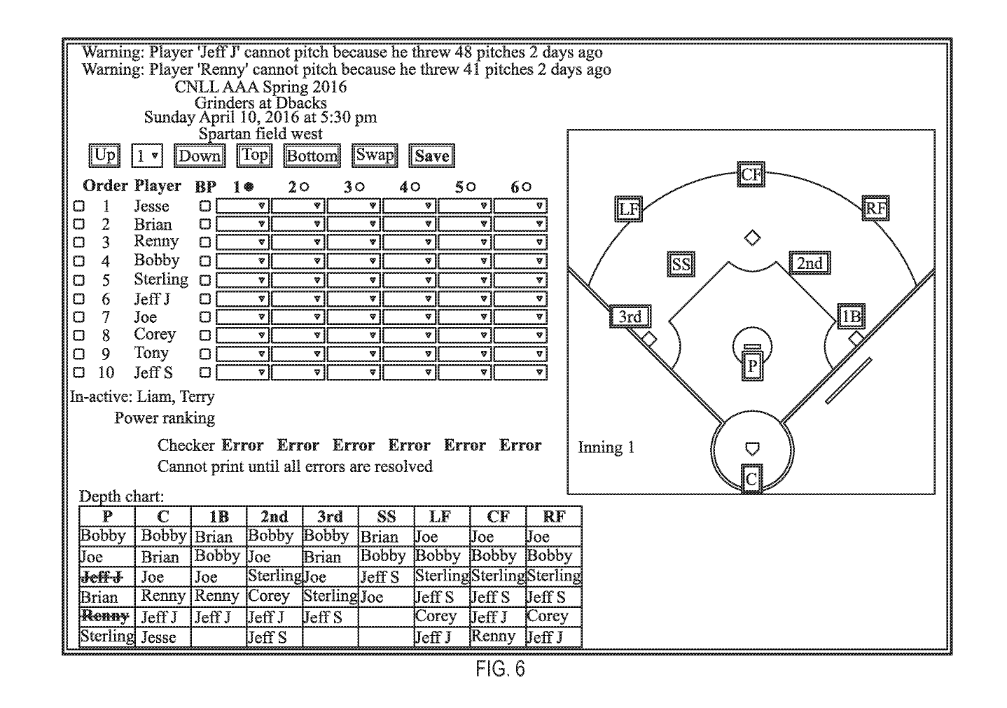

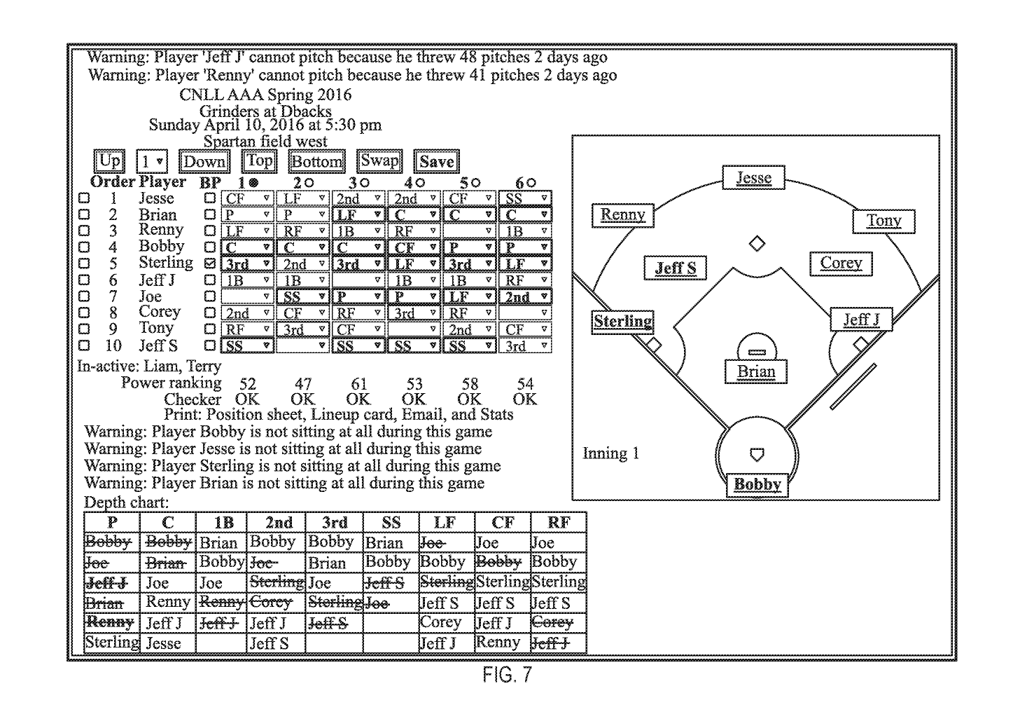

In an embodiment, once a game is defined and scheduled, the batting and fielding order line-up for the game can be defined. Referring to FIG. 6 and FIG. 7, batting and fielding line-up pages are shown. The user will initially see a page as shown at FIG. 6, which includes a line-up title heading with league, teams playing (with designation of “home team”), and date, time and location of the game. The game line-up also includes a chart with the team roster and associated batting order. Above the title, it can be seen that player statistics for that season and applicable league rules (“policies”) are also incorporated to display any applicable warning(s) so the current game line-up may be constructed in accordance with league policies. For example, a warning may be displayed for any players not eligible to pitch in the current game due to recent pitch count exceeding a threshold based on collected statistics, in order to comply with pitch count limits and/or pitcher rest requirements, or a warning could be displayed concerning any players whose assignments do not comply with rules concerning bench assignments set forth in the league policies. A warning may be issued to assist in verification that pitching assignments, bench assignments or other player position assignments meet the league policies, for example.

The batting order may be adjusted as desired. In particular, a player's position in the batting order can be changed by selecting the checkbox adjacent the player's name and then clicking either the “Down” button or “Up” button. If the “Down” button is clicked, the player's position in the batting order is moved down the list one position each time the button is clicked. Conversely, if the “Up” button is clicked, the player's position in the batting order is moved up the list one position each time the button is clicked. As an example, FIG. 7 shows the batting order as: Jesse, Brian, Renny, Bobby, Sterling, Jeff J., Joe, Corey, Tony, and Jeff S.

The user can also define each player's field position for each of a plurality of innings. As an example, FIG. 7 shows that in the first inning, Brian will be pitching (P) and Bobby will be catching (C). Jesse will be in the Center Field (CF), Renny will be in Left Field (LF), Tony will be in Right Field (RF), Jeff J. will be at 1st Base (1B), Corey will be at 2^{nd} Base (2B), Sterling will be at 3^{rd} Base (3B), and Jeff S. will play Short Stop (SS). Since no position is assigned for Joe, he will be sitting out the first inning.

In an embodiment, a depth chart will also be displayed. A depth chart is a table including a list of positions (e.g., Pitcher, Catcher, 1^{st} Base) wherein for each of the positions, players are listed from top to bottom (strongest to weakest) based on the assigned “power ranking”. A player is crossed off to indicate he or she is either not available (already assigned to another position for that inning) or ineligible. The values shown are updated for each inning selected. The chart is used to make informed field assignments. If a player is in a position for which the player has a relatively low power ranking, it will be designated by a predetermined color (e.g., red). The ability to evaluate and assign a “Power Per Position” or strength index to each player in a particular position may also be used to construct a line-up, evaluate a line-up, point out any weaknesses in a line-up, and even suggest solutions or alternate line-ups.

In an embodiment, errors in the line-up, such as duplicate players at a single position, or a player assigned as pitcher in multiple consecutive games, will also be noted by a predetermined color. A baseball field diagram can be used to graphically illustrate the names of the players at their assigned field position by selecting an inning (e.g., by selecting a radio button associated with a particular inning). Furthermore, underneath each inning column will display ‘Error’ until the assignments for the inning are validated (complete, not duplicated, and in accordance with league rules), in which case the word ‘OK’ will be displayed. By hovering over ‘Error’, the user will see any remaining issues with the line-up. After the positions are selected and the data saved, the team game line-up page may look like the page displayed at FIG. 7.

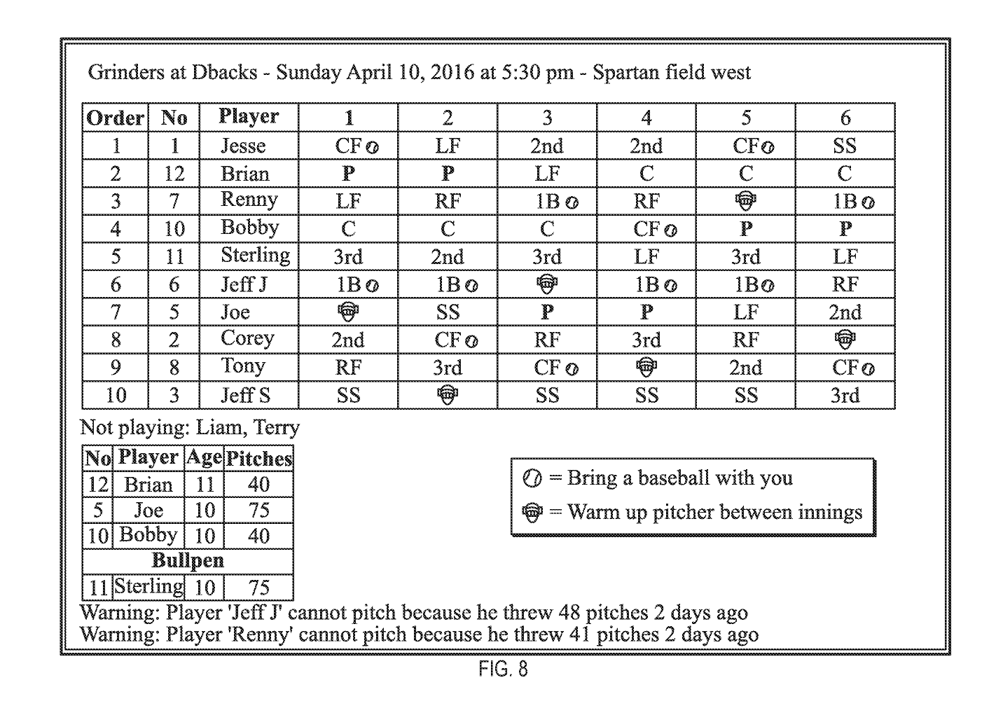

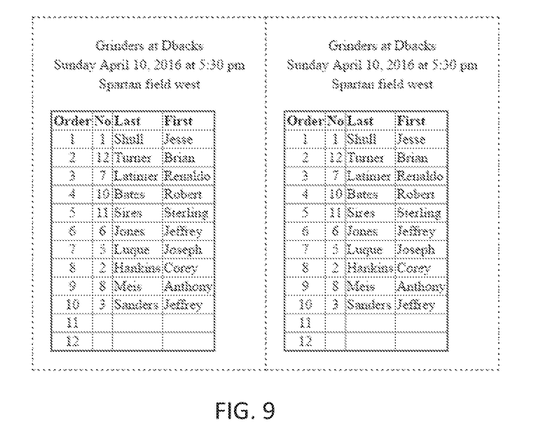

In an embodiment, once there are no more errors or issues to correct, the user can display and/or print the fielding line-up and batting line-up card. An example of a batting and fielding order print out is shown at FIG. 8. An example line-up card is shown at FIG. 9. Notably, the fielding order print out can further include reminder icons such as shown (e.g., an image of a baseball to remind the player to bring a baseball with them out to their position for warm up, an image of a catcher's mask to assign the player to warm up the pitcher between innings). Other relevant player restrictions may also be generated. As shown, a warning is noted that Jeff J. and Renny will not be allowed to pitch due to league rules forbidding overuse of pitchers. Additionally, the maximum number of pitches of Brian, Joe and Bobby are noted, along with their respective ages. Furthermore, it is noted that Sterling will be assigned to the bullpen (a potential relief pitcher) during the game.

Calculate Batting and Pitching Statistics Module 206

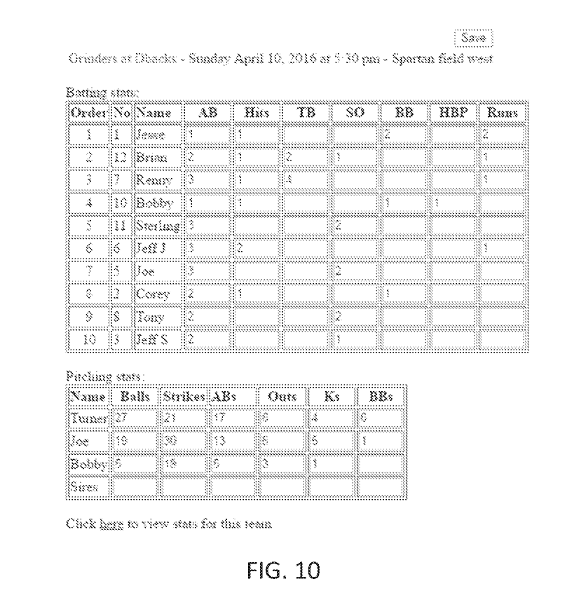

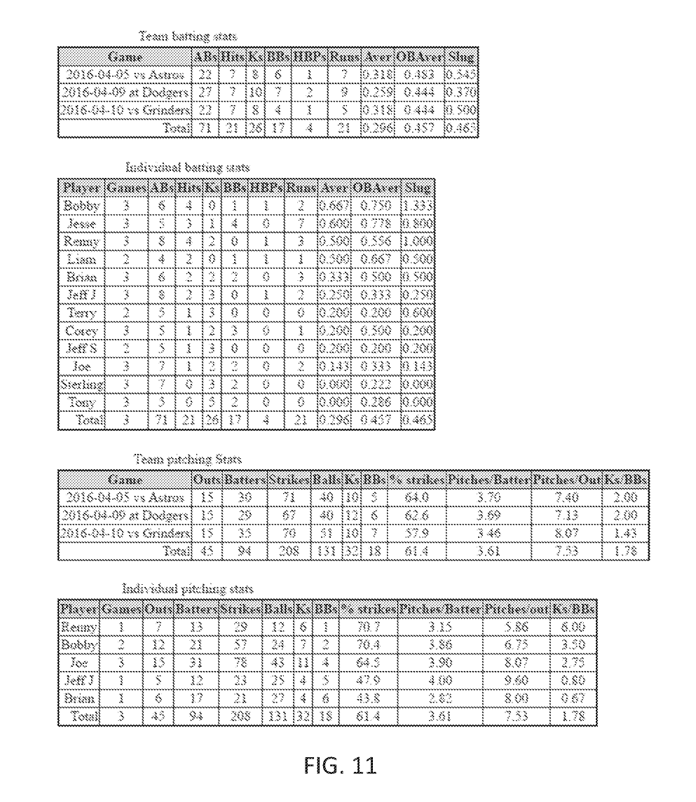

In an embodiment, the application 125 is also capable of capturing applicable batting and pitching statistics providing coaches with valuable feedback. After each game has been played, the user may collect and input batting and pitching statistics. These statistics will be of assistance in constructing future game line-ups in accordance with league rules, as discussed above. An example statistics page with batting and pitching statistics is shown at FIG. 10. In addition, cumulative team statistics charts, such as team and individual batting statistics charts and team and individual pitching statistics charts, are shown at FIG. 11.

As noted, the application 125 defines league-specific rules (policies) such as pitch count limits and pitcher rest requirements, to assist in verification that pitching assignments meet the rules. Advantageously, updates may be issued, or access may be provided, to update the league rules in the application as needed in accordance with any amendments to the rules, to ensure the application 125 consistently prepares a line-up that complies with current league rules. The inventive system and application allow coaches and managers to easily create a batting and fielding line-up that meets the league rules, is void of errors, and is easy for players and coaches to follow.

Other features may optionally be included. An “auto line-up” feature can be provided, which enables the application 125 to determine which players play to assign specific field positions based on power ranking and constraints such as league rules and the like. In an embodiment, the team profile includes an inning importance ranking (IIR) (e.g., inning 3, inning 4, inning 5, inning 6, inning 1, inning 2) and a position importance ranking (PIR) (e.g., Pitcher, Catcher, Short Stop, 1^{st} Base, 3^{rd} Base, Center Field, Left Field, Right Field). Using league policies, power ranking, inning importance ranking, position importance ranking, list of ineligible players, and a list of inactive players, a line-up can be automatically generated. As an example, the user manually assigns the pitchers and catchers for the entire game, and then selects an “Auto Assign” option to direct the system decide the remaining position assignments. The Auto Assign option makes decisions based on the predefined position and inning importance rankings and the player position strength data, incorporating the various policies, to arrive at position assignments that are complete, optimal and compliant.

In various embodiments, the application 125 may also accommodate and utilize more detailed individual player and team statistics. Further, the batting statistics may be displayed on the batting order page, which may help the user make batting order decisions. In addition, the application may optionally define 9 or 10 players on the field. Further, the application may optionally include a “one click” feature to email batting/fielding information and/or individual player or team statistics to coaches with one mouse click. An additional optional feature allows logged in users to send in notifications including comments, enhancements and bugs, or to post comments and suggestions on a community forum accessible to registered users.

As mentioned, the application 125 may be coded in any suitable computer language. In an embodiment, the application 125 is coded primarily in PHP. In this embodiment, the application accesses a MySQL database, an open source relational database system developed by Oracle Corporation.

In an embodiment, the data base 125 and the rules base 127 are stored (or logically arranged) together in the same data base. The schema for the data base can include a collection of data structures such as “Member,” “League,” “Team,” “Player,” “Game,” “Batting Order,” “Player Positions,” “Statistics,” and “Policies,” as described below.

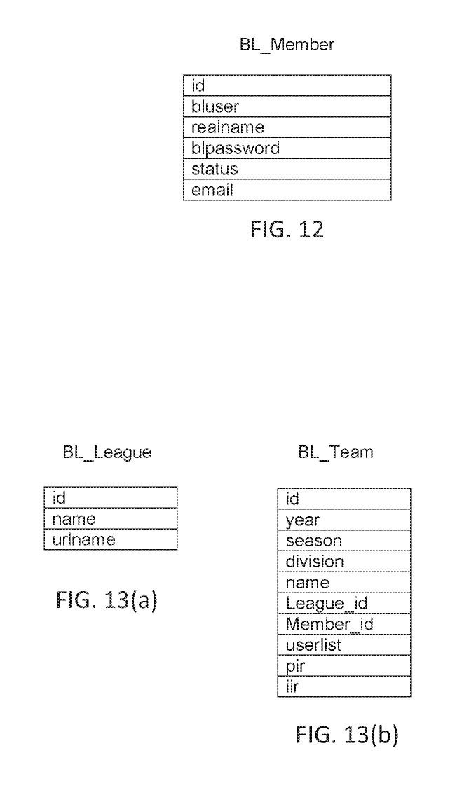

An example Member data structure is shown in FIG. 12. The Member data structure includes data associated with user profiles of users (members), such as, for example, a user id (“bluser”), a user name (“realname”), a password (“blpassword”), a current status (“status”), and an email address (“email”).

An example League data structure is shown in FIG. 13(a). The Member data structure includes data associated with the league to which several baseball team belongs. This can include the league name (“name”) and the Website address (URL) of the league (“urlname”).

An example Team data structure is shown in FIG. 13(b). The Team data structure includes data associated with the team, such as, for example, the year (“year”), a season (“season”), a division (“division”), a team name (“name”), a league logo (“League_id”), a league member id (“Member_id”), and user list for the team (“userlist”). Multiple Teams can be maintained, each having records per year/season. Additionally, for the “Auto Assign” option, the Team data structure will include an Inning Importance Ranking (“iir”) and Position Importance Ranking (“pir”).

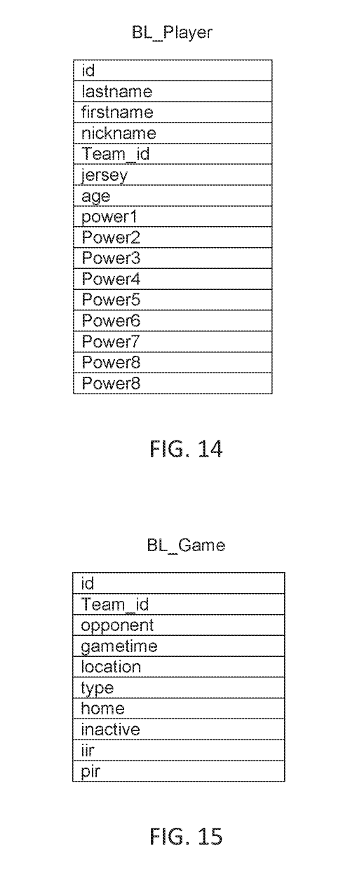

An example Player data structure is shown in FIG. 14. The Player data structure includes data associated with the team roster. There will be multiple records, one for each player on the roster including the player's last name (“lastname”), first name (“first name”), and nickname (“nickname”), a team identifier (“Team_id”), a jersey number (“jersey”), an age (“age”) and an array of nine power rankings wherein each array element is associated with a proficiency level for an individual field position (pitcher, catcher, first base, second base, third base, shortstop, left field, center field, and right field).

An example Game data structure is shown in FIG. 15. The Game data structure includes data associated with each scheduled game, such as, for example, a team identifier (“Team_id”), an opponent team name (“opponent”), a game time (“gametime”), a location for the game (“location”), a game type, such ‘regular’ or post-season (“type”), an indicator as to whether the game is played at home (“home”), and an indicator whether the game is inactive (“inactive”) As games are scheduled, a new record defining the game will be created. Additionally, for the “Auto Assign” option, the Team data structure will include an Inning Importance Ranking (“iir”) and Position Importance Ranking (“pir”).

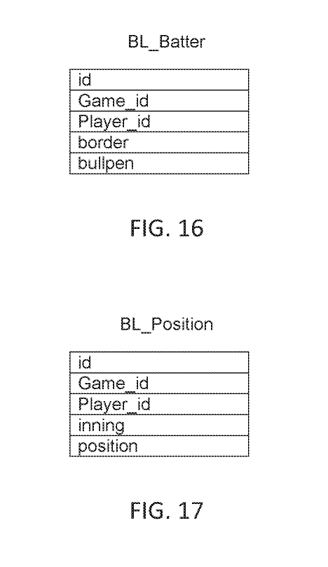

An example Batting Order data structure is shown in FIG. 16. The Batting Order data structure includes data associated with the batting order for a particular game. It can include the game identifier (“Game_Id”), and for each player, a player identifier (“Player_id”) and his or her position in the batting order (“border”). It can also include whether the player is assigned to warm up the bullpen instead of taking a position on the field (“bullpen”).

An example Player Positions data structure is shown in FIG. 17. The Player-Position data structure includes data associated with the each player's position during each inning of a particular game, such as, and will include a game identifier (“Game_id”) and for each player a player identifier (“Player_id”) and a list of positions (“position”) for each inning number (“inning”).

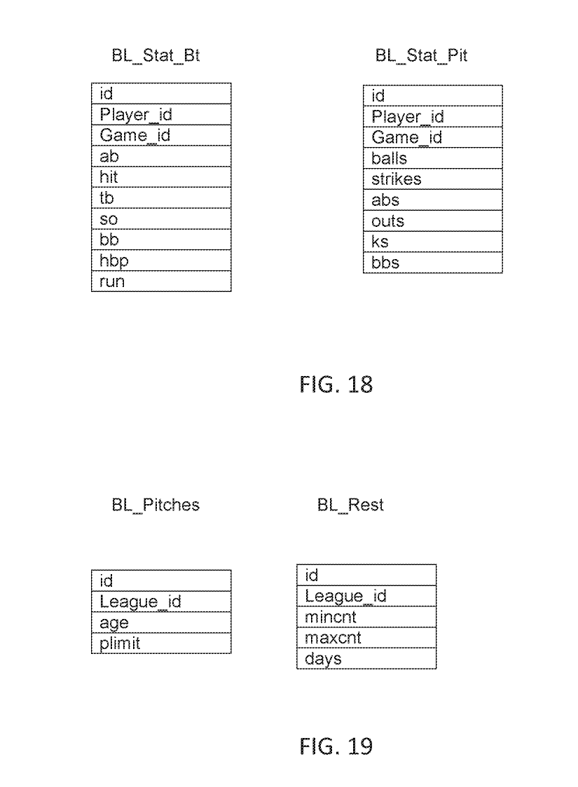

Example Statistics data structures are shown at FIG. 18, and include values for at number of at bats (“ab”), number of hits (“hits”), number of bases (“tb”), strike outs (“so”), walks (aka bases on balls) (“bb”), hit by pitch counts (“hbp”), and number of runs (“runs”). In Youth baseball, there is no such thing as ERA (earned run average) because it is very difficult to distinguish between a hit and an error in order to determine a hit vs. an error. The useful batting statistics for Youth baseball include batting average, on base average, and slugging percentage. Calculating these statistics requires knowing data such as at-bats, hits, walks, strikeouts, total bases, and runs. The useful pitching statistics include percent strikes and number of pitches per out. Calculating these statistics requires knowing data such as number of strikes, number of balls, number of batters, number of outs, number of strikeouts, and number of walks.

Example Policies data structures are shown at FIG. 19. Each league has rules, mostly for pitchers, to emphasize safety. These rules (“policies”) can be overlaid onto the pitching plan and past statistics may be utilized to verify the rules are not being violated. As shown on the left side, a data structure defines a first rule for a league (“League_id”) specifying the maximum number of pitches for a player (“plimit”) of a particular age (“age”). There will multiple records, one per each applicable player age. As shown on the left side, another data structure defines a second rule for a league (“League_id”) specifying the allowable minimum (“mincnt”) and maximum (“maxcnt”) number of days of rest (“days”) for players on the team

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A computer-implemented method for creating a baseball line-up, comprising the steps of:
accepting user input defining a line-up comprising a plurality of field position assignments;
accessing a rule base having a set of predetermined policies;
determining whether the game line-up is in compliance with the set of predetermined policies; and
if it is determined that the game line-up is not in compliance with the predetermined policies, displaying a message to that effect.

2. The method of claim 1, further comprising the steps of:
determining whether the game line-up is complete and includes no error; and
if it is determined that the game line-up is incomplete or includes an error, displaying a message to that effect.

3. The method of claim 1, further comprising the step of:
creating a position chart for the game.

4. The method of claim 1, further comprising the step of:
creating a line-up card for the game.

5. The method of claim 1, further comprising accepting user input defining a batting order.

6. The method of claim 1, further comprising the step of:
for each player on a roster of the team, accepting user input assigning a score associated with each of a plurality of baseball positions.

7. The method of claim 6, wherein the score denotes an estimated proficiency level.

8. The method of claim 6, wherein the game line-ups for each of the innings includes a cumulative score for an entire team line-up for an inning.

9. The method of claim 1, wherein the defined line-up further comprises bench assignments.

10. The method of claim 1, wherein the step of accepting user input defining the line-up further comprises displaying, as the user input defining the line-up is accepted, a graphical representation of a baseball field illustrating the line-up so far.

11. The method of claim 10 further comprising the steps of:
determining whether the game line-up is complete and includes no error; and
if it is determined that the game line-up is incomplete or includes an error, displaying a message to that effect.

12. The method of claim 11, further comprising graphically displaying a depth chart for a selected inning.

13. The method of claim 12, wherein an indication that a player is unavailable is shown on the depth chart.

14. The method of claim 1, wherein the policies stipulate one or more of a maximum number of pitches for a pitcher, a maximum number of consecutive innings or games pitched by a pitcher, pitcher rest requirements, minimum play time requirements, and rotation of players among different positions.

15. A system for creating a baseball line-up, comprising:
a server; and
a client;
wherein the client and the server are linked via a network and communicate in accordance with a request-response protocol;
wherein the client is configured to accept user input defining a baseball line-up comprising a plurality of field position assignments; and
wherein the server is configured to receive a request from the client regarding validation of the line-up.

16. The system of claim 15, wherein the validation includes validation of one or more predetermined policy.

17. The system of claim 16, wherein the validation of the one or more predetermined policy access by the server to a database table.

18. The system of claim 16, wherein the one or more policy stipulate one or more of a maximum number of pitches for a pitcher, a maximum number of consecutive innings or games pitched by a pitcher, pitcher rest requirements, minimum play time requirements, and rotation of players among different positions.

19. The system of claim 15, wherein the client is further configured to graphically display a representation of a baseball field showing the line-up for a selected inning.

20. A non-transient computer readable medium containing program instructions for causing a computer to perform the method of:
accepting user input defining a line-up comprising a plurality of field position assignments;
accessing a rule base having a set of predetermined policies;
determining whether the game line-up is in compliance with the set of predetermined policies.
